(19) United States
(12) Patent Application Publication
(10) Pub. No.: US 2026/0271873 A1
(43) Pub. Date: Sep. 17, 2026

(54) FALSE-DETECTION PREVENTION LITTER BOX

(71) Applicant: PetPivot INC, PORTLAND, OR (US)

(72) Inventor: TIEQIANG TANG, Shaoyang City (CN)

(21) Appl. No.: 19/683,734

(22) Filed: May 21, 2026

Related U.S. Application Data
(63) Continuation of application No. 18/392,864, filed on Dec. 21, 2023, now Pat. No. 12,685,291.

(30) Foreign Application Priority Data
Dec. 14, 2023 (CN) 202323406907.1

(51) Int. Cl. A01K 1/01; A01K 29/00; G01G 23/00

(52) U.S. Cl. CPC A01K 1/0114; A01K 29/005; G01G 23/002

(57) ABSTRACT

The present disclosure provides a false-detection prevention litter box. The litter box includes a litter box main body, a supporting platform, a first supporting leg and a weighing sensor. The weighing sensor includes a connecting part and a sensing part. The sensing part of the weighing sensor is configured to sense a change in a weight of the litter box main body. The connecting part of the weighing sensor is connected to the litter box main body. One end of the first supporting leg is connected to the supporting platform, and the other end of the first supporting leg is provided with a metal part. The metal part has a first abutting portion configured to abut against the sensing part.

### CROSS-REFERENCE TO RELATED APPLICATIONS

This application is a continuation in part of U.S. application serial No. 18/392,864, filed on Dec. 21, 2023, the content of which is incorporated by reference herein.

### TECHNICAL FIELD

The present disclosure relates to a litter box, and in particular, to a false-detection prevention litter box, which is applied to the technical field of pet supplies.

### BACKGROUND

At present, more and more people like to keep pets in their spare time. In the process of keeping pets, the problem of excretion of the pets has always bothered owners. Cats are taken as an example. A litter box or a cat toilet is usually used by pet cats, but the litter box or the cat toilet needs to be cleaned timely. Otherwise, for people, the strong odor of excrements of the cats will affect indoor air; and for cats, they will no longer be willing to defecate in the litter box or the cat toilet and will change their defection places or refrain from defecating. Those who are familiar with cats know that if a cat does not defecate for three days, its health will be directly affected.

Therefore, some existing intelligent litter boxes or cat toilets are provided with weighing devices to record and visually reflect a weight and defecation information of a cat by monitoring a weight of a box body, so as to know defecation time and a defecation amount and learn about a basic health status of the cat.

At present, the weighing sensor of the existing litter box is arranged between a supporting leg and a supporting seat. The supporting leg is configured to support the supporting seat in a suspended state, and the supporting leg is fixedly connected to the supporting seat. The arrangement of the weighing sensor has the following defects: 1. When the ground is uneven, this arrangement will be affected by the uneven ground, leading to a zero drift. As a result, an error occurs in measurement of the weighing sensor. 2. Due to the contact between the supporting leg and the ground, the weighing sensor can only work on the hard ground, and the ground needs to be even, otherwise, the weighing sensor is inaccurate in measurement. 3. If a user directly drags and moves the product on the ground, the weighing sensor will be easy to damage, causing inaccurate subsequent measurement of the weighing sensor of the product, or causing a weight measurement function of the product to fail.

### SUMMARY

In view of the problems in the prior art mentioned above, the present disclosure adopts the following technical solution.

A false-detection prevention litter box, wherein the false-detection prevention litter box includes a litter box main body, a supporting platform, a first supporting leg, and a weighing sensor, wherein the weighing sensor includes a connecting part and a sensing part; the sensing part of the weighing sensor is configured to sense a change in a weight of the litter box main body; the connecting part of the weighing sensor is connected to the litter box main body; one end of the first supporting leg is connected to the supporting platform, and the other end of the first supporting leg is provided with a metal part, the metal part having a first abutting portion configured to abut against the sensing part.

Beneficial effects of the present disclosure are as follows. The present disclosure provides a false-detection prevention litter box. The false-detection prevention litter box includes a litter box main body, a supporting platform, a first supporting leg, and a weighing sensor. The weighing sensor includes a connecting part and a sensing part. The sensing part of the weighing sensor is configured to sense a change in a weight of the litter box main body. The connecting part of the weighing sensor is connected to the litter box main body. One end of the first supporting leg is connected to the supporting platform, and the other end of the first supporting leg is provided with a metal part, the metal part having a first abutting portion configured to abut against the sensing part. With the above structure, the weight of the litter box main body can be transmitted to the weighing sensor through the metal part. Compared with direct abutting cooperation between plastic parts, the metal part has higher structural strength and better anti-deformation capability. This reduces weighing errors caused by deformation during long-term use, improves the stability and accuracy of weighing detection, reduces the occurrence of false detection or false triggering, and thus enhances the reliability of the litter box.

### BRIEF DESCRIPTION OF THE DRAWINGS

FIG. 1 is a schematic structural diagram of a litter box according to the present disclosure;

FIG. 2 is a schematic structural diagram of a litter box according to the present disclosure;

FIG. 3 is a schematic structural diagram of a first supporting leg and a weighing sensor according to the present disclosure;

FIG. 4 is a partially schematic structural diagram of a litter box according to the present disclosure;

FIG. 5 is an enlarged view of A according to the present disclosure;

FIG. 6 is an enlarged view of B according to the present disclosure;

FIG. 7 is a three-dimensional diagram of a supporting seat according to the present disclosure;

FIG. 8 is an enlarged view of C according to the present disclosure;

FIG. 9 is a three-dimensional diagram of a litter box according to the present disclosure;

FIG. 10 is a three-dimensional diagram of a base according to the present disclosure;

FIG. 11 is a three-dimensional diagram of a roller according to the present disclosure;

FIG. 12 is a schematic structural diagram of a first shell according to the present disclosure;

FIG. 13 is a schematic structural diagram of a second shell according to the present disclosure.

FIG. 14 is a cross-sectional view taken along the first supporting leg and the weighing sensor according to another embodiment of the present disclosure;

FIG. 15 is an enlarged view of D in FIG. 14;

FIG. 16 is an exploded view of the litter box main body and the supporting platform according to another embodiment of the present disclosure;

FIG. 17 is an enlarged view of E in FIG. 16;

FIG. 18 is an enlarged view of F in FIG. 16;

FIG. 19 is another exploded view of the litter box main body and the supporting platform according to another embodiment of the present disclosure;

FIG. 20 is an enlarged view of G in FIG. 19.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

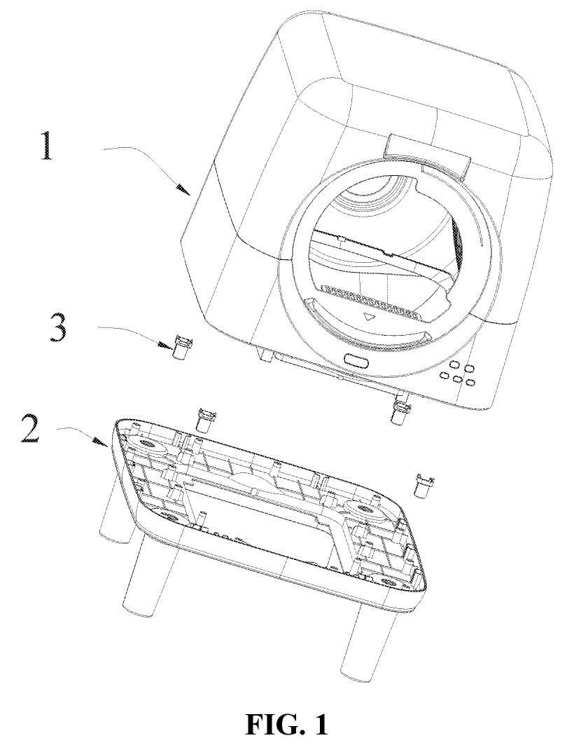

Referring to FIG. 1 to FIG. 13, a first embodiment of the present disclosure provides a false-detection prevention litter box. As shown in FIG. 1 to FIG. 3, the litter box includes a litter box main body 1, a supporting platform 2, a first supporting leg 3, and a weighing sensor 4. The weighing sensor 4 includes a connecting part 41 and a sensing part 42; the sensing part 42 of the weighing sensor is configured to sense a change in a weight of the litter box main body 1; the connecting part 41 of the weighing sensor is connected to the litter box main body 1; the sensing part 42 of the weighing sensor is connected to one end of the first supporting leg 3; and the other end of the first supporting leg 3 is abutted with the supporting platform 2. That is, one end of the first supporting leg is abutted with the supporting platform, the other end of the first supporting leg is connected to the sensing part of the weighing sensor, and the connecting part of the weighing sensor is connected to the litter box main body, so that the first supporting leg is always abutted with the supporting platform, and the weighing sensor will not be in a suspended state and can precisely detect a weight change generated by the litter box main body, which solves the problem of a measurement error of the weighing sensor in the prior art. It should be noted that the supporting platform refers to a platform surface. Due to the platform surface, when the litter box is on an uneven ground, the first supporting leg can always be abutted with the platform surface to ensure that the weighing sensor is not in the suspended state, so that even if the litter box is placed on the uneven ground or on a carpet or soft mat, and the weighing sensor will not have a detection error. This expands an application range of a user and improves the user experience.

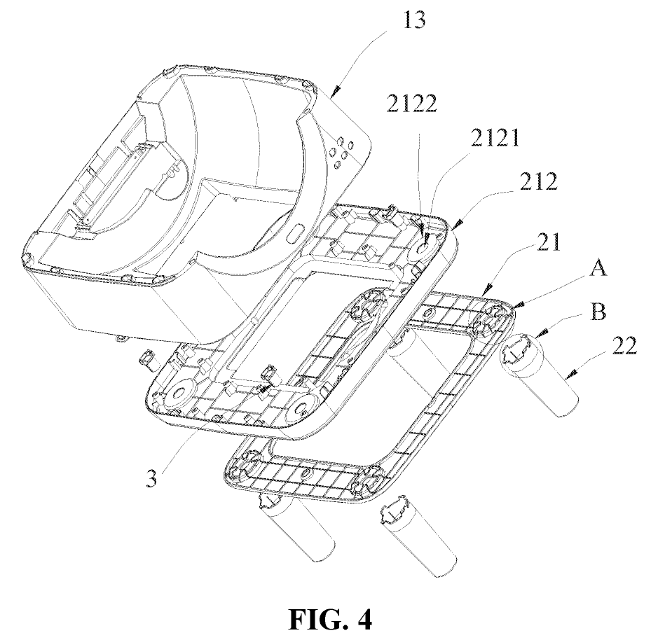

In this embodiment, as shown in FIG. 4, the supporting platform 2 includes a weighing platform 21 and a second supporting leg 22; the weighing platform 21 is mounted on the second supporting leg 22; one end of the first supporting leg 3 is abutted with the weighing platform 21; the first supporting leg 3 is correspondingly arranged above the second supporting leg 22; and the litter box main body 1 is movably mounted on the weighing platform 21. That is, the second supporting leg supports the weighing platform and the litter box main body to be in a suspended state, so that the entire litter box is more aesthetically pleasing and three-dimensional. It should be noted that the litter box main body 1 is movably mounted on the weighing platform 21. First, the weighing sensor is protected during movement of the litter box. The supporting leg of the litter box in the prior art is integrated with a base. When a user directly drags and moves the product on the ground, the weighing sensor is easy to damage, causing the product to fail. In this embodiment, the litter box main body is movably connected to the weighing platform, which is convenient for first removing the litter box main body and then moving the supporting platform, so as not to damage the weighing sensor. Secondly, the weighing sensor in this embodiment is preferably set as a resistance strain sensor, and the sensing part is a resistance strain gauge. When a weight of the resistance strain gauge changes, the resistance strain gauge deforms slightly, making detection more accurate. If the weighing platform 21 is connected and fixed to the litter box main body, the resistance strain gauge cannot move, which will cause a small error in detection. Thirdly, the first supporting leg is mainly configured to be connected to the weighing platform 21, but it is not a main acting force for supporting the litter box main body. Therefore, the litter box main body 1 is movably mounted on the weighing platform 21, and the weighing platform 21 supports the litter box main body.

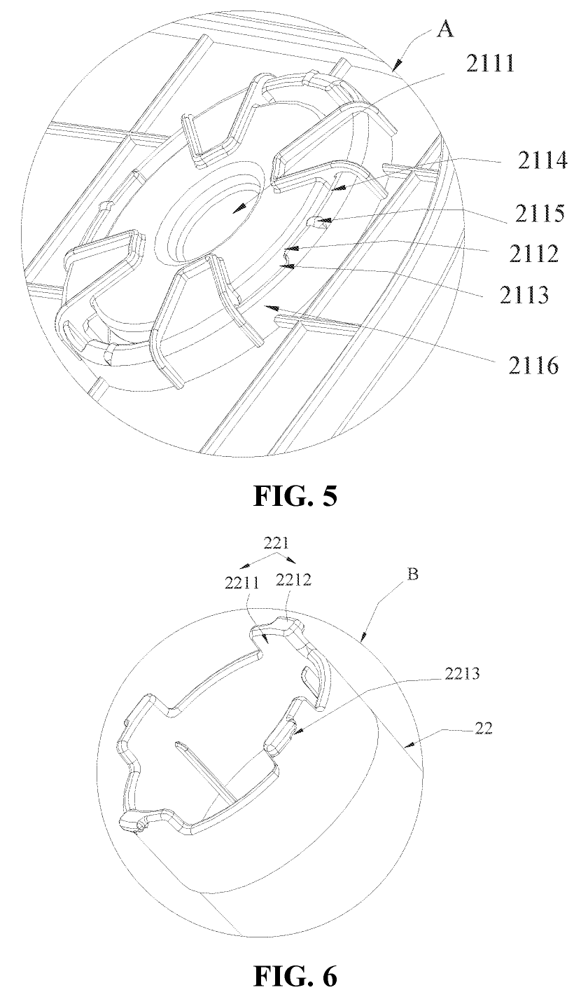

In this embodiment, as shown in FIG. 5, a mounting slot 2111 is arranged on the supporting platform 2, and one end of the first supporting leg 3 is mounted in the mounting slot 2111, so that the first supporting leg 3 achieves more stable supporting.

In this embodiment, as shown in FIG. 4 to FIG. 6, a bayonet 2112 located around the mounting slot 2111 is arranged on the weighing platform 21; a clamping member 221 is arranged around the second supporting leg 22; and the clamping member 221 passes through the bayonet 2112 from a bottom of the weighing platform 21 and is clamped to the weighing platform 21 to connect the second supporting leg to the weighing platform 21. By the arrangement of the bayonet and the clamping member, it is convenient for the mounting of the second supporting leg.

In this embodiment, as shown in FIG. 5 to FIG. 6, the clamping member 221 includes a first bulge 2211 and a second bulge 2212; the first bulge 2211 is arranged around one end connected to the weighing platform 21, and the first bulge 2211 is arranged in a longitudinal extension direction of the second supporting leg 22; the second bulge 2212 is arranged on an outer side surface of the first bulge 2211; a gap 2113 and a third bulge 2114 are arranged at the bayonet 2112; the third bulge 2114 is arranged on an outer edge of the bayonet, and the third bulge 2114 is arranged towards an interior of the bayonet 2112; when the second supporting leg 22 is mounted on the weighing platform 21, after the second bulge 2212 passes through the gap 2113, the second bulge 2212 is rotated; and the second bulge 2212 can be clamped onto the third bulge 2114. This structure mainly achieves quickly mounting the second supporting leg on the weighing platform 21 without adding other components and reducing mounting procedures. In this embodiment, the first bulge and the second bulge are integrally molded, and the third bulge 2114 and the weighing platform 21 are integrally molded. The integrated molding is convenient for demolding.

In this embodiment, as shown in FIG. 5 to FIG. 6, a surface of the third bulge 2114 is provided with a fourth bulge 2115; a surface of the second bulge 2212 is provided with a clamping slot 2213; after the second bulge passes through the gap, the second bulge 2212 can be rotated until the fourth bulge 2115 is clamped into the clamping slot 2213; or, a surface of the second bulge 2212 is provided with a fourth bulge 2115, and a surface of the third bulge 2114 is provided with a clamping slot 2213; and after the second bulge passes through the gap, the second bulge 2212 can be rotated until the fourth bulge 2115 is clamped into the clamping slot 2213. The design of this structure is mainly to prevent the second supporting leg from being separated from the weighing platform. This structure is convenient for the mounting of the second supporting leg and is simple. The fourth bulge 2115 and the third bulge 2114 of this embodiment are integrally molded. The integrated molding is convenient for demolding.

In this embodiment, as shown in FIG. 5 to FIG. 6, a surface of the fourth bulge 2115 is an arc-shaped surface; a slot surface of the clamping slot 2213 is arranged in a manner of corresponding to the surface of the fourth bulge 2115; and when the fourth bulge 2115 is clamped into the clamping slot 2213, the second bulge 2212 is rotated, and the fourth bulge 2115 can be separated from the clamping slot 2213. This facilitates mounting and removal of the first supporting leg.

In this embodiment, as shown in FIG. 4 to FIG. 6, the weighing platform 21 includes a weighing platform 21 and a mounting bottom shell 212; the mounting bottom shell 212 is mounted on the weighing platform 21; the weighing platform 21 is provided with a first boss 2116 facing the mounting bottom shell 212; the mounting bottom shell 212 is provided with a second boss 2122; the second boss 2122 is provided with a through hole 2121; the mounting slot 2111 is arranged on the first boss 2116; the through hole 2121 is arranged in a manner of corresponding to the mounting slot 2111; the second boss 2122 sleeves the first boss 2116; the litter box main body 1 is movably mounted on the mounting bottom shell 212; the mounting bottom shell 212 is provided with the through hole 2121; one end of the first supporting leg 3 is mounted in the mounting slot 2111 through the through hole 2121; and the second supporting leg 22 is arranged below the first boss 2116. This structural design is mainly to make a supporting force of the first supporting leg more stable.

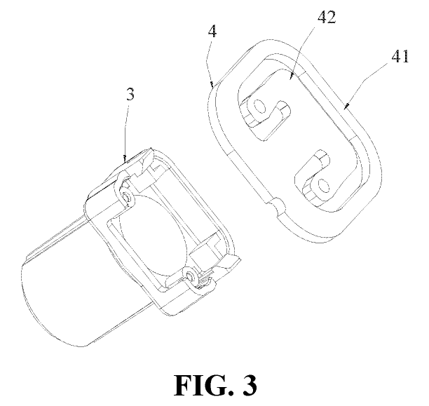

In this embodiment, as shown in FIG. 3, the connecting part 41 is arranged at a periphery of the sensing part 42; one end of the sensing part 42 is connected to the connecting part 41; and the sensing part 42 can move up and down relative to the connecting part 41. Therefore, the structure and mounting of the weighing sensor are clearer, and all connecting points are connected clearly. It is convenient for connection.

In this embodiment, the weighing sensor is a strain gauge type pressure sensor. A basic principle of the resistance strain pressure sensor is a strain effect of a resistor: When a conductor mechanically deforms, a resistance value of the conductor changes, which is referred to as “strain effect”. That is, the sensing part is a resistance strain gauge. When a weight of the litter box main body changes, the resistance value will change.

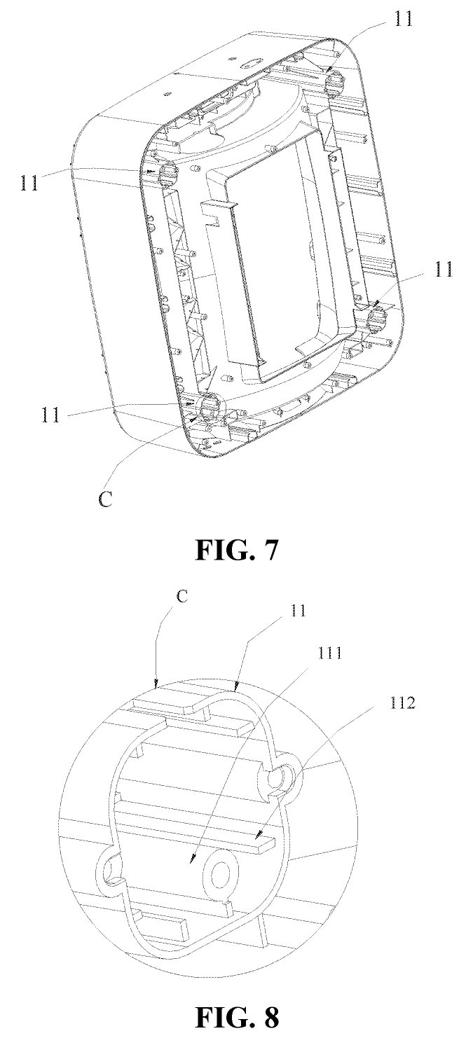

In this embodiment, as shown in FIG. 7 to FIG. 8, a hollow mounting column 11 is arranged at a bottom of the litter box main body 1; the mounting column 11 is arranged in a manner of facing the first supporting leg 3; a supporting rib 111 is arranged around an inner side wall of a cavity of the mounting column 11; the connecting part 41 is mounted on a supporting end of the supporting rib 111; the sensing part 42 is located in the cavity of the mounting column 11; and when the weight of the litter box main body 1 increases, the mounting column 11 presses the connecting part 41, and the sensing part 42 can move in the cavity of the mounting column 11. This structure is more convenient for the mounting of the weighing sensor.

In this embodiment, as shown in FIG. 7 to FIG. 8, a limiting column 112 is also arranged in the cavity of the mounting column 11; the limiting column 112 is arranged in a manner of corresponding to the sensing part 42; the limiting column 112 is slightly lower than the supporting end of the supporting rib 111; and the limiting column 112 can be configured to limit the sensing part 42. The limiting column 112 prevents an excessive pressure on the litter box and prevents an extremely high pressure on the sensing part of the weighing sensor to damage the weighing sensor.

In this embodiment, as shown in FIG. 4, the litter box main body 1, the weighing sensor 4, the first supporting leg 3, and the supporting platform 2 are arranged in sequence from top to bottom, which makes the mounting procedure clearer.

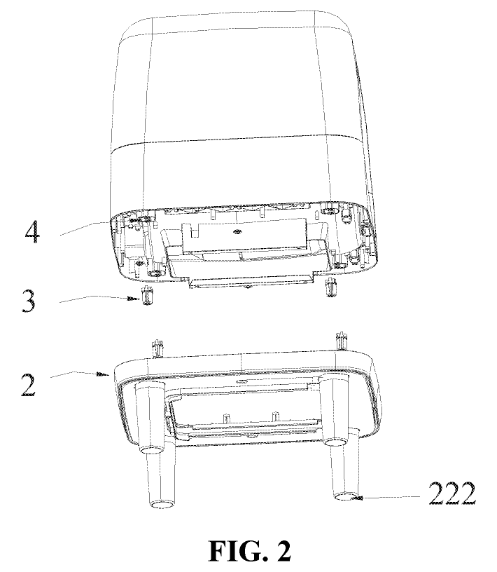

In this embodiment, as shown in FIG. 2, a foot pad 222 is arranged at a bottom of the second supporting leg 22 to protect the second supporting leg and prevent the second supporting leg from being damaged when the litter box is moved. The foot pad also has a mute effect during the movement of the litter box.

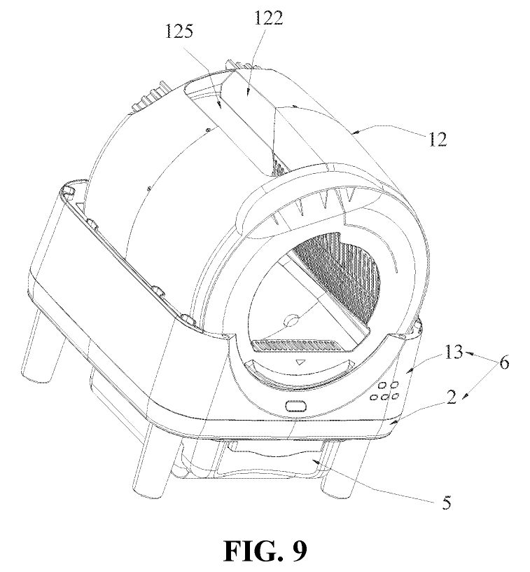

In this embodiment, as shown in FIG. 9, the litter box main body 1 includes a roller 12 and a supporting seat 13; the roller 12 is rotatably arranged on the supporting seat 13; the supporting seat 13 is arranged on the supporting platform 2; and the supporting seat 13 is connected to the supporting platform 2 to form a base 6. In this way, it is more convenient for mounting.

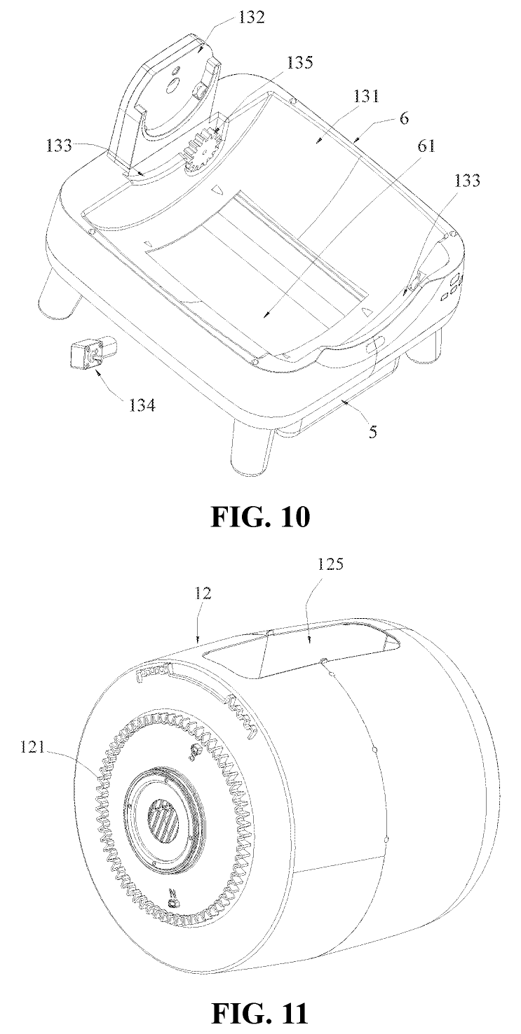

In this embodiment, as shown in FIG. 10 to FIG. 11, the base 6 is provided with a supporting column 132; a rear end surface of the roller 12 is provided with a first gear 121; an upper surface of the base 6 is sunken downwards to form an avoiding slot 131 matched with the roller 12; one end of the supporting column 132 located in the avoiding slot 131 is opposite to an end surface of the roller 12; the avoiding slot 131 is provided with a carrying slot 133 for carrying two ends of the roller 12; the base 6 is provided with a motor 134 configured to drive the roller 12 to rotate; a rotating shaft of the motor 134 is connected with a second gear 135 engaged with the first gear 121; and the second gear 135 is located on the carrying slot 133. In this way, when the motor drives the second gear to rotate, the roller rotates through the first gear.

In this embodiment, as shown in FIG. 10 to FIG. 11, an integral partition plate 122 and a sifter 123 are arranged in the roller 12; the integral partition plate 122 forms an accommodating slot 124 with an inner wall of the roller 12 and is integrally molded with the roller 12; a first opening 125 is formed in one side of the roller 12 far from a notch of the accommodating slot 124; when the roller 12 rotates, litter and waste are sifted through the sifter 123; and when the roller continues to rotate, the waste is rotated to the first opening 125 along the integral partition plate 122. In this embodiment, the integral partition plate and the roller 12 are integrally molded, which can effectively reduce the assembling process of the integral partition plate, reduce the production procedure of the litter box, and improve the production efficiency of the litter box. In this way, there is no joint between the integral partition plate and the roller 12, which can prevent the litter from being left in the joint and facilitate cleaning of a litter bin.

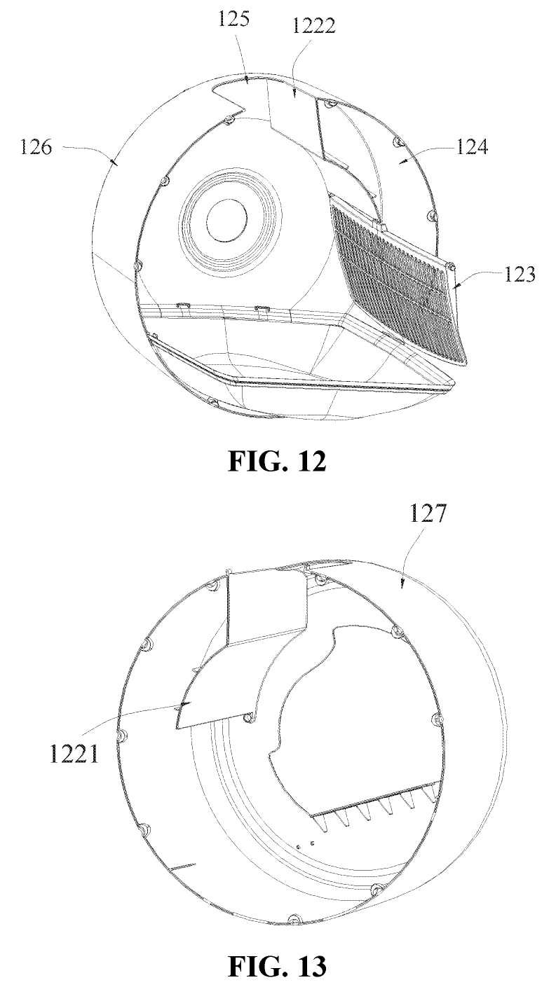

In this embodiment, as shown in FIG. 12 to FIG. 13, the roller 12 includes a first shell 126 and a second shell 127 connected to the first shell 126; the integral partition plate 122 includes a first partition plate 1221 integrally molded with the first shell 126 and a second partition plate 1222 integrally molded with the second shell 127; and the first partition plate 1221 and the second partition plate 1222 form the integral partition plate 122 when the first shell is connected to the second shell 127. It can be understood that the first shell is a front half part of the roller 12, and the second shell is a rear half part of the roller 12. The first opening 125 is formed by connecting the first shell to the second shell. Of course, in other embodiments, the first shell and the second shell can also be a left half part and a right half part of the roller 12.

In this embodiment, as shown in FIG. 12 to FIG. 13, the litter box further includes a collection box 5; the collection box 5 is arranged at a bottom of the base 6; a second opening 61 communicated to the collection box 5 is formed in the base 6; the roller 12 rotates relative to the base 6; and when the second opening 61 is opposite to the first opening 125, the waste falls into the collection box 5 through the second opening 61 and the first opening 125 in sequence. The collection box 5 is convenient to take down, and it is convenient for a user to clean waste of a pet regularly.

In this embodiment, the collection box 5 is detachably arranged at the bottom of the base 6. In this way, the collection box 5 can be suspended, and it is convenient to take out the collection box 5.

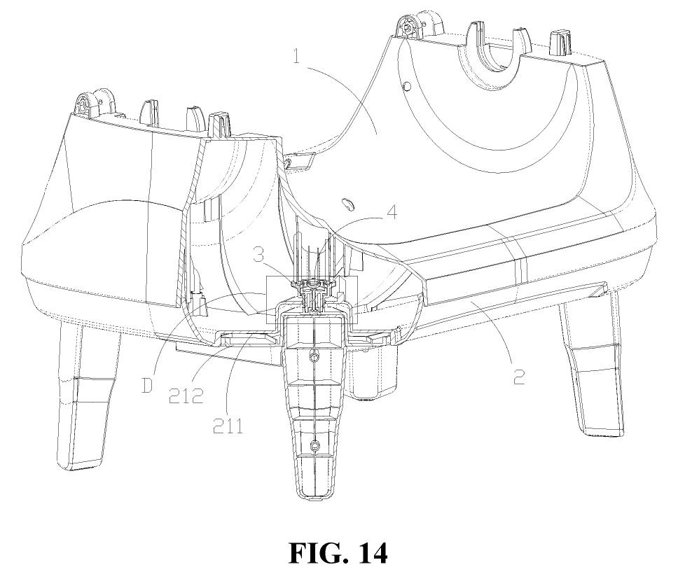

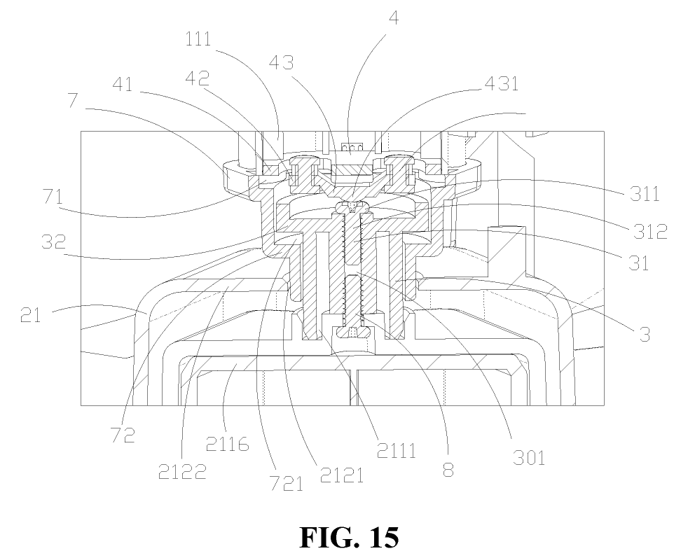

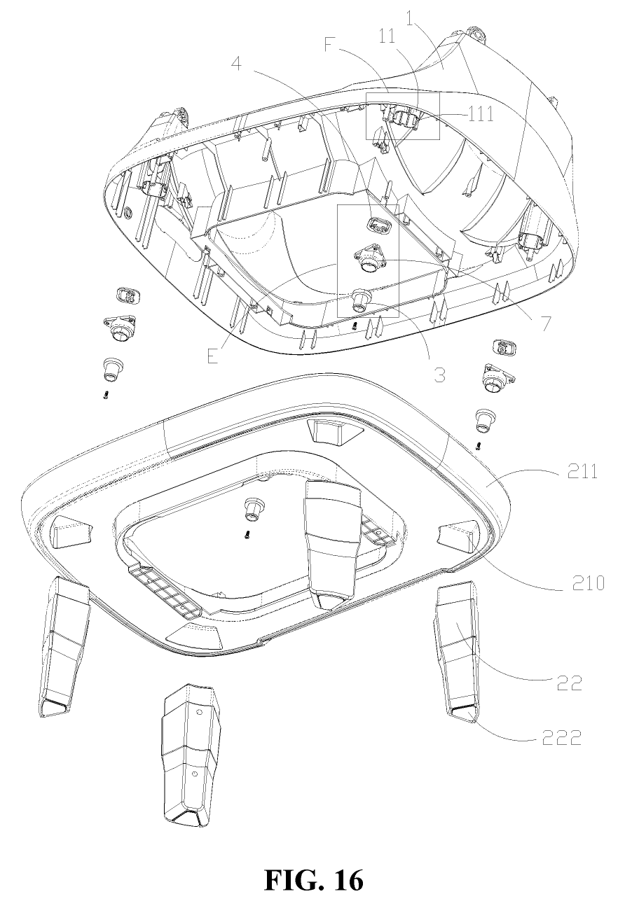

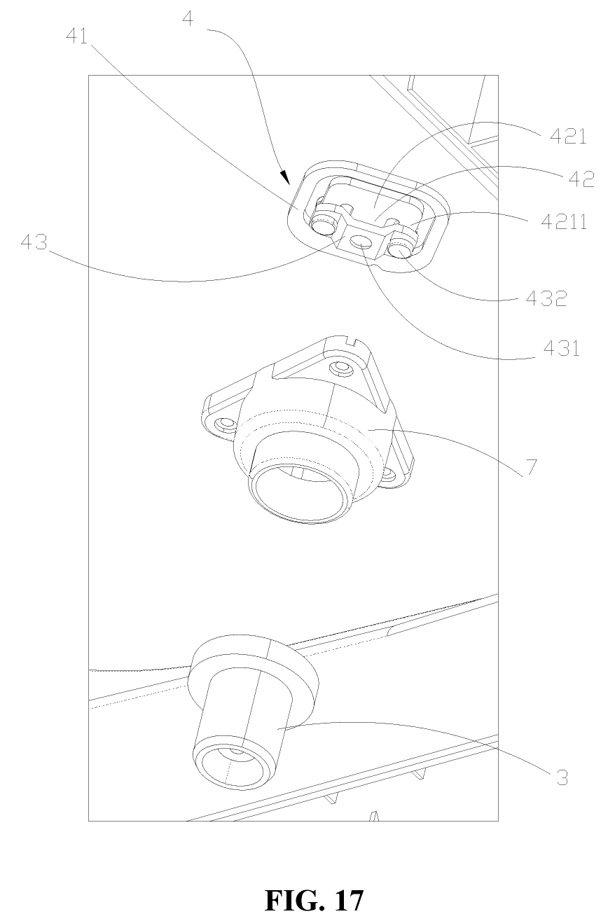

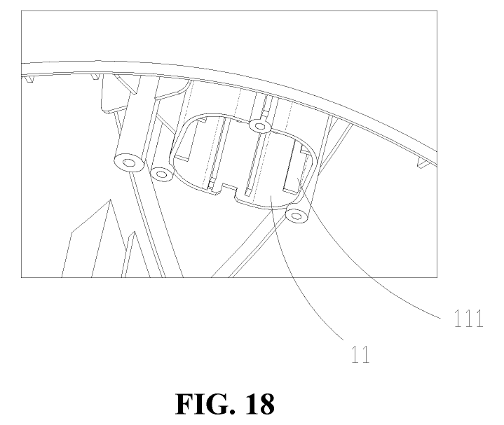

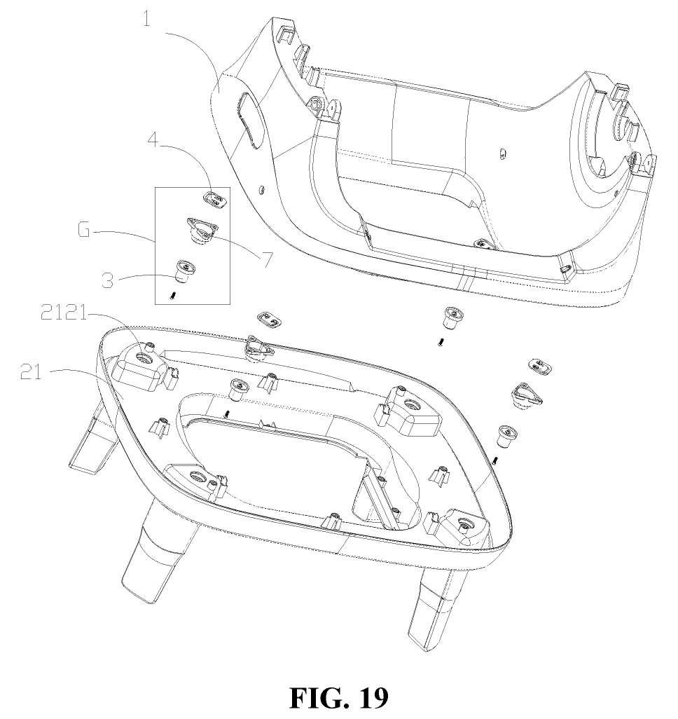

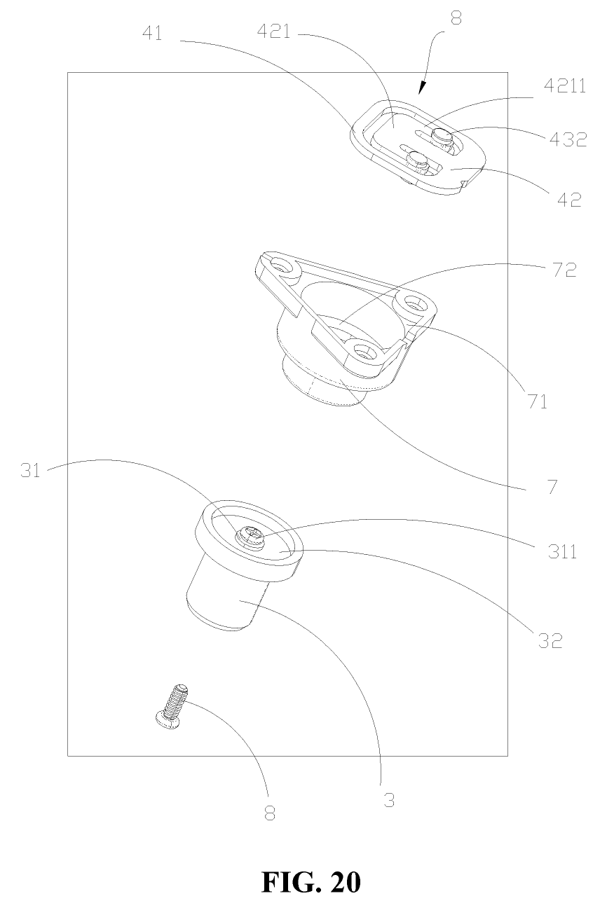

Referring to FIG. 1 and FIGS. 14-20, a second embodiment of the present disclosure provides a false-detection prevention litter box. The false-detection prevention litter box includes a litter box main body 1, a supporting platform 2, a first supporting leg 3, and a weighing sensor 4. The weighing sensor 4 includes a connecting part 41 and a sensing part 42. The sensing part 42 of the weighing sensor is configured to sense a change in a weight of the litter box main body 1. The connecting part 41 of the weighing sensor is connected to the litter box main body 1. One end of the first supporting leg 3 is connected to the supporting platform 2, and the other end of the first supporting leg 3 is provided with a metal part 31. The metal part 31 has a first abutting portion 311 configured to abut against the sensing part 42. With the above structure, one end of the first supporting leg 3 is connected to the supporting platform 2, and the other end is provided with the metal part 31 having the first abutting portion 311 that abuts against the sensing part 42 of the weighing sensor 4, so that the weight of the litter box main body 1 can be transmitted to the weighing sensor 4 through the metal part 31. Compared with direct abutting cooperation between plastic parts, the metal part 31 has higher structural strength and better anti-deformation capability. This reduces weighing errors caused by deformation during long-term use, improves the stability and accuracy of weighing detection, reduces the occurrence of false detection or false triggering, and thus enhances the reliability of the litter box.

In this embodiment, the sensing part 42 is connected with a pressure receiving member 43. The pressure receiving member 43 has a second abutting portion 431 matching the first abutting portion 311. The first abutting portion 311 and the second abutting portion 431 are in point contact with each other. The pressure receiving member 43 is a metal pressure receiving member 43. The first abutting portion 311 and/or the second abutting portion 431 is a spherical surface structure. The pressure receiving member 43 is connected below the deformation portion 421. With the above structure, by connecting the pressure receiving member 43 to the sensing part 42 and providing the pressure receiving member 43 with the second abutting portion 431 matching the first abutting portion 311, a point contact is formed between the first abutting portion 311 and the second abutting portion 431, reducing the contact area, lowering the influence of assembly deviation or force offset on weighing detection, and thereby improving the sensitivity and accuracy of weight transmission. Furthermore, since the pressure receiving member 43 is a metal pressure receiving member 43, deformation during use is reduced, thereby helping maintain the stability of weighing data.

In this embodiment, the deformation portion 421 includes two symmetrically arranged cantilever portions 4211, and two ends of the pressure receiving member 43 are respectively connected to the two cantilever portions 4211 via fasteners 432. With the above structure, by providing the deformation portion 421 as two symmetrically arranged cantilever portions 4211 and connecting the two ends of the pressure receiving member 43 to the two cantilever portions 4211 via the fasteners 432, the pressure receiving member 43 can uniformly transmit pressure to the two cantilever portions 4211 when stressed, thereby improving the balance of the force on the deformation portion 421 and reducing detection deviation caused by excessive local stress.

In this embodiment, the first supporting leg 3 is provided with a threaded hole 301 arranged in an axial direction. The metal part 31 is a first threaded member 312 threadedly connected to the first supporting leg 3 via the threaded hole 301. The metal part 31 is arranged at a central portion of the first supporting leg 3. With the above structure, the installation stability and connection reliability of the metal part 31 are improved, reducing the occurrence of loosening or deviation during use, thereby ensuring the stability of weight transmission. Furthermore, the threaded connection allows adjustment of the protruding height of the first threaded member 312, facilitating adjustment of the abutting state between the first abutting portion 311 and the sensing part, thereby improving assembly accuracy and weighing detection accuracy.

In this embodiment, the supporting platform 2 includes a weighing platform 21. The end of the first supporting leg 3 away from the weighing sensor 4 is connected to the weighing platform 21. The litter box main body 1 is movably mounted on the weighing platform 21.

In this embodiment, a hollow mounting column 11 is arranged at a bottom of the litter box main body 1. The mounting column 11 is arranged in a manner of facing the first supporting leg 3. Supporting ribs 111 are arranged around an inner side wall of a cavity of the mounting column 11. The litter box further includes a limiting sleeve assembly 7. The limiting sleeve assembly 7 is connected to a lower end of the mounting column 11. The limiting sleeve assembly 7 has a limiting pressure plate 71. The limiting pressure plate 71 presses the connecting part 41 against supporting ends of the supporting ribs 111. The sensing part 42 is located in the cavity of the mounting column 11. When the weight of the litter box main body 1 increases, the mounting column 11 presses the connecting part 41, and the sensing part 42 deforms in the cavity of the mounting column 11. With the above structure, by connecting the end of the first supporting leg 3 away from the weighing sensor 4 to the supporting platform 2 and movably mounting the litter box main body 1 on the supporting platform 2, the weight of the litter box main body 1 can be stably transmitted to the weighing sensor 4, facilitating accurate detection of weight changes of the litter box main body 1. Furthermore, by providing the hollow mounting column 11 facing the first supporting leg 3 at the bottom of the litter box main body 1 and locating the sensing part 42 in the cavity of the mounting column 11, a deformation space is provided for the sensing part 42. By arranging the supporting ribs 111 around the inner side wall of the cavity of the mounting column 11 and using the limiting pressure plate 71 of the limiting sleeve assembly 7 to press the connecting part 41 against the supporting ends of the supporting ribs 111, the weighing sensor 4 is prevented from shifting or shaking. Moreover, when the weight of the litter box main body 1 increases, the mounting column 11 presses the connecting part 41, causing the sensing part 42 to deform in the cavity of the mounting column 11. This structure facilitates the installation of the weighing sensor.

In this embodiment, the limiting sleeve assembly 7 is movably sleeved on an outer side of the first supporting leg 3. The end of the first supporting leg 3 close to the weighing sensor 4 extends outwardly to form a first limiting boss 32. The limiting sleeve assembly 7 has a second limiting boss 72 located below the first limiting boss 32. A movement gap 721 is provided between the first limiting boss 32 and the second limiting boss 72 in an axial direction. When the litter box main body 1 is in a weighing state, the metal part 31 abuts against the sensing part 42, and the movement gap 721 exists between the first limiting boss 32 and the second limiting boss 72. When the litter box main body 1 is lifted upward, the metal part 31 separates from the sensing part 42, and the second limiting boss 72 moves upward to abut against the first limiting boss 32.

With the above structure, by movably sleeving the limiting sleeve assembly 7 on the outer side of the first supporting leg 3 and providing the first limiting boss 32 on the first supporting leg 3 and the second limiting boss 72 below the first limiting boss 32 on the limiting sleeve assembly 7, a movement gap 721 is formed between the first limiting boss 32 and the second limiting boss 72. Thus, when the litter box main body is in a weighing state, the metal part 31 can stably abut against the sensing part. When the litter box main body is lifted upward, the metal part 31 separates from the sensing part, and the second limiting boss 72 moves upward to abut against the first limiting boss 32, providing a limiting support for the litter box main body, preventing the weighing sensor and the first supporting leg from shifting, and reducing the pulling or impact on the weighing sensor during handling or lifting of the litter box main body, thereby protecting the weighing sensor and extending its service life.

In this embodiment, the weighing platform 21 includes a first weighing platform 211 and a second weighing platform 212. The second weighing platform 212 is mounted on the first weighing platform 211. The first weighing platform 211 is provided with a first boss 2116 facing the second weighing platform 212. The second weighing platform 212 is provided with a second boss 2122. The second boss 2122 is provided with a through hole 2121. A mounting slot 2111 is provided above the first boss 2116. The through hole 2121 is arranged corresponding to the mounting slot 2111. The second boss 2122 sleeves the first boss 2116. The litter box main body 1 is movably mounted on the second weighing platform 212. One end of the first supporting leg 3 passes through the through hole 2121 and is mounted in the mounting slot 2111. The first supporting leg 3 is threadedly mounted in the mounting slot 2111 via a second threaded member 8. The above structure effectively achieves stable installation of the first supporting leg 3.

In this embodiment, the supporting platform 2 further includes a weighing platform 21 and a second supporting leg 22. The weighing platform 21 is mounted on the second supporting leg 22, and the first supporting leg 3 is correspondingly arranged above the second supporting leg 22. Specifically, a leg mounting slot 210 is provided at a bottom of the weighing platform 21, and a head portion of the second supporting leg 22 is press-fitted into the leg mounting slot 210 via an interference fit. With the above structure, using an interference fit allows reliable installation without additional complicated fastening structures, improving assembly efficiency.

In this embodiment, the weighing sensor 4 is a strain gauge type pressure sensor. The basic principle of the resistance strain pressure sensor is the strain effect of a resistor: when a conductor mechanically deforms, its resistance value changes, which is referred to as the "strain effect". That is, the sensing part is a resistance strain gauge. When the weight of the litter box main body changes, the resistance value changes.

In this embodiment, the litter box main body 1, the weighing sensor 4, the first supporting leg 3, and the supporting platform 2 are arranged in sequence from top to bottom, making the assembly process clearer.

In this embodiment, a foot pad 222 is arranged at a bottom of the second supporting leg 22 to protect the second supporting leg and prevent damage when moving the false-detection prevention litter box, and also to provide a muting effect during movement.

The above is only the preferred embodiments of the present disclosure, and is not intended to limit the present disclosure. Any modifications, equivalent replacements and improvements that are made within the spirit and principle of the present disclosure shall fall within the protection scope of the present disclosure.

1. A false-detection prevention litter box, wherein the litter box comprises a litter box main body, a supporting platform, a first supporting leg, and a weighing sensor; the weighing sensor comprises a connecting part and a sensing part; the sensing part of the weighing sensor is configured to sense a change in a weight of the litter box main body; the connecting part of the weighing sensor is connected to the litter box main body; a first end of the first supporting leg is connected to the supporting platform, and a second end of the first supporting leg is provided with a metal part, the metal part having a first abutting portion configured to abut against the sensing part.

2. The false-detection prevention litter box according to claim 1, wherein the sensing part is connected with a pressure receiving member, the pressure receiving member having a second abutting portion matching the first abutting portion; the first abutting portion and the second abutting portion are in point contact with each other.

3. The false-detection prevention litter box according to claim 2, wherein the sensing part comprises a deformation portion extending inwardly from the connecting part, and the pressure receiving member is connected below the deformation portion.

4. The false-detection prevention litter box according to claim 2, wherein the pressure receiving member is a metal pressure receiving member.

5. The false-detection prevention litter box according to claim 2, wherein the deformation portion comprises two symmetrically arranged cantilever portions; two ends of the pressure receiving member are respectively connected to the two cantilever portions via fasteners.

6. The false-detection prevention litter box according to claim 1, wherein the first supporting leg is provided with a threaded hole arranged in an axial direction; the metal part is a first threaded member threadedly connected to the first supporting leg via the threaded hole.

7. The false-detection prevention litter box according to claim 1, wherein the metal part is arranged at a central portion of the first supporting leg.

8. The false-detection prevention litter box according to claim 2, wherein the supporting platform comprises a weighing platform; the end of the first supporting leg away from the weighing sensor is connected to the weighing platform; the litter box main body is movably mounted on the weighing platform.

9. The false-detection prevention litter box according to claim 8, wherein a hollow mounting column is arranged at a bottom of the litter box main body; the mounting column is arranged in a manner of facing the first supporting leg; supporting ribs are arranged around in an inner side wall of a cavity of the mounting column; the false-detection prevention litter box further comprises a limiting sleeve assembly, and the limiting sleeve assembly is connected to a lower end of the mounting column and has a limiting pressure plate; the limiting pressure plate presses the connecting part against supporting ends of the supporting ribs; the sensing part is located in the cavity of the mounting column.

10. The false-detection prevention litter box according to claim 9, wherein when the weight of the litter box main body increases, the mounting column is configured for pressing the connecting part, and the sensing part is configured to deform in the cavity of the mounting column.

11. The false-detection prevention litter box according to claim 9, wherein the limiting sleeve assembly is movably sleeved on an outer side of the first supporting leg; the end of the first supporting leg close to the weighing platform extends outwardly to form a first limiting boss; the limiting sleeve assembly has a second limiting boss located below the first limiting boss; a movement gap is provided between the first limiting boss and the second limiting boss in an axial direction; when the litter box main body is in a weighing state, the metal part abuts against the sensing part, and the movement gap exists between the first limiting boss and the second limiting boss; when the litter box main body is lifted upward, the metal part separates from the sensing part, and the second limiting boss moves upward to abut against the first limiting boss.

12. The false-detection prevention litter box according to claim 11, wherein the weighing platform comprises a first weighing platform and a second weighing platform mounted on the first weighing platform; the first weighing platform is provided with a first boss in a manner of facing the second weighing platform; the second weighing platform is provided with a second boss; the second boss is provided with a through hole; a mounting slot is provided above the first boss; the through hole is arranged corresponding to the mounting slot; the second boss sleeves the first boss; the litter box main body is movably mounted on the second weighing platform; one end of the first supporting leg passes through the through hole and is mounted in the mounting slot.

13. The false-detection prevention litter box according to claim 12, wherein the first supporting leg is threadedly mounted in the mounting slot via a second threaded member.

14. The false-detection prevention litter box according to claim 1, wherein the supporting platform further comprises a weighing platform and a second supporting leg; the weighing platform is mounted on the second supporting leg, and the first supporting leg is correspondingly arranged above the second supporting leg.

15. The false-detection prevention litter box according to claim 14, wherein a leg mounting slot is provided at a bottom of the weighing platform, and a head portion of the second supporting leg is press-fitted into the leg mounting slot via an interference fit.

16. The false-detection prevention litter box according to claim 1, wherein the weighing sensor is a strain gauge type pressure sensor.

17. The false-detection prevention litter box according to claim 1, wherein the litter box main body, the weighing sensor, the first supporting leg, and the supporting platform are arranged in sequence from top to bottom.

18. The false-detection prevention litter box according to claim 14, wherein a foot pad is arranged at a bottom of the second supporting leg.

19. The false-detection prevention litter box according to claim 2, wherein the first abutting portion and/or the second abutting portion is a spherical surface structure.

20. The false-detection prevention litter box according to claim 1, wherein the litter box main body comprises a roller and a supporting seat; the supporting seat is arranged on the supporting platform; the supporting seat is connected to the supporting platform to form a base; and the roller is rotatably arranged on the base.
